(19) United States
(12) Patent Application Publication
(10) Pub. No.: US 2020/0281437 A1
(43) Pub. Date: Sep. 10, 2020

(54) CLEANING DEVICE AND METHOD FOR CLEANING ARTICLES TO BE CLEANED

(71) Applicant: MEIKO Maschinenbau GmbH & Co. KG, Offenburg (DE)

(72) Inventors: Andreas FALLERT, Weinbergweg 5 (DE); Bruno GAUS, Offenburg (DE); Thomas PEUKERT, Bühl (DE); Hans-Josef RAUBER, Oberhamersbach (DE)

(21) Appl. No.: 16/754,370

(22) PCT Filed: Sep. 28, 2018
(86) PCT No.: PCT/EP2018/076413

§ 371 Date: Apr. 7, 2020

(30) Foreign Application Priority Data
Sep. 29, 2017 (DE) 10 2017 217 427.7

(51) Int. Cl. A47L 15/00; B08B 13/00; B08B 3/08; A47L 15/46; A47L 15/42; A47L 15/48; B08B 9/08

(52) U.S. Cl. CPC A47L 15/0076; B08B 13/00; B08B 3/08; A47L 15/46; A47L 2401/12; A47L 15/4285; A47L 15/486; B08B 9/08; A47L 15/4297

(57) ABSTRACT

A cleaning device (110) for cleaning articles (112) to be cleaned is proposed. The cleaning device (110) includes at least one cleaning chamber (118) for receiving the articles (112) to be cleaned. In addition, the cleaning device (110) includes at least one application device (124) for acting upon the articles (112) to be cleaned with at least one cleaning fluid. The cleaning device (110) additionally comprises at least one cooling surface (158) which points to the cleaning chamber (118) and at least one cooling container (160) which is thermally coupled with the cooling surface (158) for receiving a cooling liquid. The cleaning device (110) comprises at least one control system (178) which is set up to control at least one regeneration step in the cleaning device (110). The regeneration step includes the following substeps:
d) fill the cooling container (160) with cooling liquid;
e) heat the cooling liquid in the cooling container (160); and
f) remove the cooling liquid from the cooling container (160).

### TECHNICAL SCOPE

The invention relates to a method and to a cleaning device for cleaning articles to be cleaned, in particular for use in industrial dishwashing technology and/or in large kitchens. Cleaning devices of the named type can be used, for example, in devices for community catering, such as, in particular, in gastronomy, in works canteens, canteens in schools, public authorities, hospitals or care facilities. The cleaning device can be used, in particular, for cleaning articles to be cleaned in the form of items to be washed which are used directly or indirectly for the preparation, storage or presentation of food and beverages. In particular, in this case, this can be crockery and/or trays. Other areas of use of the present invention are also conceivable in principle, in particular areas of use with fundamentally arbitrary items to be washed, for example medical instruments or care utensils.

### TECHNICAL BACKGROUND

A plurality of cleaning devices, also designated as cleaning machines, which can clean and/or disinfect articles to be cleaned, are disclosed in the prior art. The invention refers below, without limiting other possible areas of use, significantly to industrial washing technology, for example industrial dishwashing technology. Thus, along with program dishwashers with static washing methods, conveyor dishwashing machines or tunnel dishwashing machines are also known where the articles to be cleaned are conveyed by means of a conveyor device through one or multiple cleaning chambers. Program dishwashing machines, also designated as automatic program machines, which are set up for industrial use, as a rule have two circuits for washing liquid, that is to say along with the actual fluid tank which is accommodated in the cleaning chamber, via which the circulation mode is effected, also at least one rinse tank for the separate preparation of rinse fluid or final rinse fluid, for example with a boiler or flow heater. Other designs are also possible.

In particular, in the case of single chamber dishwashing machines and in this case, in particular, automatic program machines, but sometimes also in the case of conveyor dishwashing machines, the drying of exhaust air and the air dehumidification inside the cleaning chamber provide a technical challenge. In particular, air dehumidification can be conducive to improved drying action.

U.S. Pat. No. 2,918,068 A discloses a dishwasher with a closed cleaning chamber for receiving the items to be washed and perpendicular walls with inner and outer surfaces and a drying device for drying items that have been washed without emitting water vapor into the surrounding air. The drying device includes circulation means for circulating the air in the chamber, moisture on the inner surface being condensed and the condensation being supported by air cooling.

DE 10 2008 040 745 A1 discloses a washing method for a dishwashing machine. The dishwashing machine includes a washing container which defines the washing chamber and in which, during or after a wash cycle has been carried out, washing liquid no longer required is stored temporarily in a storage container coupled thermally with the washing container. In a drying step of the wash cycle, the air or water vapor located in a washing chamber of the washing container and loaded with moisture is condensed on at least one side wall of the washing container. Prior to or during the drying step, the storage container is filled with fresh water to prepare a condensation surface.

DE 10 2013 014 553 A1 describes an automatic cleaning machine and a method for operating an automatic cleaning machine. The automatic cleaning machine includes a cleaning chamber which is delimited by walls, at least one of the walls being cooled on an outside surface by a fluid. A blower is arranged on a ceiling of the cleaning chamber. With the automatic cleaning machine in drying mode, a closed air circuit is realized inside the cleaning chamber. The at least one wall cooled by a fluid forms a dehumidifying section for an air flow flowing along said section.

DE 3 316 716 A1 describes a method for recycling waste heat in a domestic dishwashing machine and a machine for carrying out the method. Used in this case is a storage container which is connected to the washing container so as to conduct heat and is filled with cold water in each case when the cleaning or the final rinse temperature is reached and, by outputting part quantities, is emptied in each case for the pre-wash and the wash or for the intermediate rinse and the final rinse.

In spite of the advantages achieved with the described devices and methods, there is still in part potential for improvement. Thus, as a rule, cooling containers, which can be produced, for example, from plastics material or metal, for example as welded injection parts or as blow-molded parts, are used for providing the condensation surfaces. Said containers abut, as a rule, flatly against a wall on the outside of the cleaning chamber or are integrated into the wall so that heat can be transmitted in the one or other direction. The containers are, as a rule, empty as a result of the program sequence or when the machine is switched off. As residual moisture always remains in the containers, as a rule, and said containers comprise a certain residual heat, for example 40-60° C., dropping over time, coatings can be formed in the containers. Said coatings can grow until they impair the heat transmission to the wall of the cleaning chamber and consequently impair the efficiency of the device. In addition, said coatings can grow until cross sections in the containers are restricted or even blocked so that efficiency can also be restricted or even prevented.

The described containers are also not usually accessible without serious assembly work so that manual cleaning, for example within the framework of a daily cleaning routine or even within the framework of maintenance, is difficult to accomplish. In addition, even the transmission of heat between the container and the interior of the cleaning chamber represents a technical challenge in many cases, heat transmission in many cases dropping over time as a result of the above-described coatings.

### OBJECTIVE OF THE INVENTION

It would be desirable, consequently, to provide a cleaning device and a method for cleaning articles to be cleaned which address at least to a great extent the above-described technical challenges of known cleaning machines and methods of the named type. In particular, efficient drying of the air inside the cleaning chamber is to be made possible, while at the same time avoiding the formation of coatings in cooling containers to the maximum extent possible and permanently maintaining as far as possible a heat transmission that does not drop.

### DISCLOSURE OF THE INVENTION

Said object is addressed by a cleaning device and a method with the features of the independent claims. Advantageous further developments which are realizable individually or in arbitrary combination are provided in the dependent claims.

The terms “have”, “comprise”, “include” or “incorporate” or arbitrary grammatical deviations thereof are used below in a non-exclusive manner. Accordingly, said terms can refer both to situations in which, along with the features introduced by said terms, no further features are present, or to situations in which one or multiple further features are present. For example, the expression “A has B”, “A comprises B”, “A includes B” or “A incorporates B” can refer both to the situation in which, apart from B, no further element is present in A (i.e. to a situation in which A consists exclusively of B), and to the situation in which, in addition to B, one or multiple further elements are present in A, for example element C, elements C and D or even further elements.

It is additionally pointed out that the terms “at least one” and “one or multiple” and grammatical modifications of said terms, when they are used in conjunction with one or multiple elements or features and are to express that the element or feature can be provided singly or multiple times, are used, as a rule, just once, for example when the feature or element is introduced for the first time. When the feature or element is mentioned again subsequently, the corresponding term “at least one” or “one or multiple” is, as a rule, no longer used, without limitation to the possibility that the feature or element can be provided once or multiple times.

Furthermore, the terms “preferably”, “in particular”, “for example” or similar terms are used below in connection with optional features without alternative embodiments being restricted as a result. Thus, features which are introduced by said terms are optional features, and there is no intention of restricting the extent of protection of the claims and in particular of the independent claims by said features. Thus, the invention, as the expert will realize, can also be carried out by using other designs. In a similar manner, features which are introduced by “in an embodiment of the invention” or by “in an exemplary embodiment of the invention”, are understood as optional features without, as a result, having to restrict alternative designs or the extent of protection of the independent claims. In addition, all possibilities for combining the features introduced hereby with other features, whether they be optional or non-optional features, are to remain unchanged by said introductory expressions.

A cleaning device for cleaning articles to be cleaned is proposed in a first aspect of the present invention. The cleaning device includes at least one cleaning chamber for receiving the articles to be cleaned. In addition, the cleaning device includes at least one application device for acting upon the articles to be cleaned with at least one cleaning fluid. The cleaning device additionally comprises at least one cooling surface which points to the cleaning chamber and at least one cooling container which is thermally coupled with the cooling surface for receiving a cooling liquid. The cleaning device additionally comprises at least one control system which is set up to control at least one regeneration step in the cleaning device, wherein the regeneration step includes the following substeps:
a) fill the cooling container with cooling liquid;
b) heat the cooling liquid in the cooling container; and
c) remove the cooling liquid from the cooling container.

A method for cleaning articles to be cleaned is proposed in a further aspect of the present invention, which method includes the following steps:
I. provide at least one cleaning device, including at least one cleaning chamber for receiving the articles to be cleaned, additionally including at least one application device for acting upon the articles to be cleaned with at least one cleaning fluid, wherein the cleaning device additionally comprises at least one cooling surface which points to the cleaning chamber and at least one cooling container which is thermally coupled with the cooling surface for receiving a cooling liquid;
II. carry out at least one regeneration step in the cleaning device, including the following substeps:
   a. fill the cooling container with cooling liquid;
   b. heat the cooling liquid in the cooling container; and
   c. remove the cooling liquid from the cooling container.

The substeps of the regeneration step of the cleaning device and of the method are preferably carried out in the named sequence. In this case, however, the substeps can also, for example, overlap in time so that, for example, the heating of the cooling liquid can already be carried out during the filling process, or so that, for example, the cooling liquid can be heated again whilst it is being removed from the cooling container, for example whilst it is being pumped or drained out of the cooling container. However, separation of the method steps is also possible.

The cleaning device can be set up, in particular, for carrying out the proposed method, and the method can be carried out, in particular, using the proposed cleaning device. In this respect, the cleaning device and the method will be described together below.

The term “cleaning device”, as used here, is a further term, to which its usual and common meaning is to be attributed, as understood by the expert. The term is not limited to a special or adapted meaning. The term can, without limitation, refer, in particular, to a device which is set up in order to rid articles to be cleaned at least in part from adhering contaminants and/or germs. The cleaning device can be, for example, a dishwashing machine, in particular an industrial dishwashing machine, for example a single-chamber dishwashing machine and/or a program dishwashing machine. The concept according to the invention can also be used, in principle, however, in pass-through dishwashing machines. As an alternative to this or in addition to it, the cleaning device can, however, also be designed completely or in part as a cleaning and disinfection unit, for example as a cleaning device which is set up to clean containers for receiving human excrements. In general, reference can be made in this regard, for example, to the cleaning devices described in DE 10 2004 056 052 A1 and/or in DE 10 2007 025 263 A1. The cleaning device can also be a washing machine, as can be used for cleaning containers in the environment of food production and/or food processing. In addition, the cleaning device can be a disinfecting washing machine, for example a washing machine for cleaning and disinfection of breathing masks. Other designs, however, are also conceivable in principle. The invention is described below in particular in conjunction with industrially usable single-chamber dishwashing machines or automatic program machines which, along with the actual wash tank or wash container which is arranged in the majority of cases in the floor of the cleaning chamber, have a separate rinse container in which rinsing liquid can already be prepared during a wash cycle. Other designs, however, are also possible in principle.

The term “articles to be cleaned”, as used here, is a further term to which its usual and common meaning is to be attributed, as understood by the expert. The term is not limited to a special or adapted meaning. The term can, without limitation, refer, in particular, to objects or products which can be subjected to a cleaning process or a cleaning method. Without limitation of further possible designs, reference is made below, in this case, to articles to be cleaned in the form of items to be washed. Items to be washed are to include, in this case, any objects which are provided for the preparation, presentation or storage of food and beverages. Items to be washed such as cups, plates, glasses, shells or bowls can be named as examples in this connection. In addition, pans, trays, cutlery, warming devices or similar devices are to be named However, it is pointed out expressly that other types of articles to be cleaned can also be cleaned, such as, for example, industrial piece goods, bulk material, containers or other types of articles to be cleaned.

The term “cleaning” can, without limitation, be understood both as ridding the articles to be cleaned of adhering dirt or other contaminants and as a germ-reducing and/or germicidal action or even a disinfecting action. Hygienization is to be understood, in principle, as both the getting rid of germs, in particular a germ-reducing and/or germicidal or even disinfecting action, and the getting rid of substances such as chemicals, for example residues of additives in the at least one cleaning fluid.

The term “cleaning chamber”, as used here, is a further term to which its usual and common meaning is to be attributed, as understood by the expert. The term is not limited to a special or adapted meaning. The term can, without limitation, refer, in particular, to a chamber in which the above-described cleaning operation of the articles to be cleaned is carried out in full or in part. In particular, the articles to be cleaned can be acted upon in a cleaning chamber with the cleaning fluid or with one of multiple cleaning fluids. The chamber is preferably surrounded fully or in part by a housing. As stated above, the cleaning device can be, in particular, a single chamber cleaning device, that is to say a cleaning device which comprises precisely one chamber for receiving the articles to be cleaned, in particular for stationary reception, which is preferably completely surrounded by walls of the cleaning chamber. A closable opening, for example a flap, a door or a slide, can be provided in at least one wall of the cleaning chamber. As an alternative to this or in addition to it, at least part of at least one wall of the cleaning chamber can, however, also be designed so as to be movable in order to enable the articles to be cleaned to be received in the cleaning chamber. The described cleaning chamber can thus comprise, for example, at least one cover or can be closed fully or in part by at least one cover.

The cleaning fluid can be, for example, a cleaning liquid and/or a gaseous cleaning fluid. For example, said cleaning fluid can include a cleaning liquid, for example an aqueous cleaning liquid, for example water in the form of fresh water and/or with one or multiple additives, for example with one or multiple cleaner concentrates and/or one or multiple final rinse concentrates and/or one or multiple disinfection means. For example, the cleaning fluid can comprise one additive or multiple additives, for example at least one additive selected from the group consisting of a cleaner concentrate, a rinse agent and a disinfection means. As an alternative to this or in addition to it, the cleaning fluid can include, for example, vapor. Other designs, however, are also conceivable in principle. The at least one cleaning fluid can include, in principle, for example, at least one cleaning liquid, in particular at least one aqueous cleaning liquid. Other types of cleaning fluids are also usable in principle. A “cleaning fluid”, can consequently be understood therefore, without limitation to further possible designs, as an arbitrary fluid, in particular as a liquid which is able to exert a cleaning action on the articles to be cleaned.

The term “application device”, as used here, is a further term to which its usual and common meaning is to be attributed, as understood by the expert. The term is not limited to a special or adapted meaning. The term can, without limitation, refer, in particular, to an arbitrary device or combination of devices, by means of which the articles to be cleaned are acted upon with the cleaning fluid, for example as a result of spraying, irradiating or dripping cleaning fluid on the articles to be cleaned. For example, the application device can comprise at least one nozzle system. For example, one or multiple nozzles can be provided in the cleaning chamber above and/or below the articles to be cleaned and/or also to the side of the articles to be cleaned. For example, the nozzles can include one or multiple spray arms above the articles to be cleaned and one or multiple spray arms below the articles to be cleaned, in particular rotatable spray arms.

The term “cooling surface”, as used here, is a further term to which its usual and common meaning is to be attributed, as understood by the expert. The term is not limited to a special or adapted meaning. The term can, without limitation, refer, in particular, to a surface, via which a heat exchange can take place. In particular, the term cooling surface can refer to an inner wall of the cleaning chamber which points to the cleaning chamber, the inner wall being able to be cooled on an outside surface, which is arranged outside the cleaning chamber, by at least one cooling medium, in the present case the cooling liquid. In other words, the cooling surface can be or comprise an inner wall of the cleaning chamber which can be cooled on an outside surface directly or indirectly by a cooling medium, in particular the cooling liquid, that is to say can be brought to a temperature below an inner temperature of the cleaning chamber. Condensation can thus be effected, in particular, on the cooling surface in the interior of the cleaning chamber. The cooling surface can include, in particular, a surface of at least a vertical inner wall of the cleaning chamber, that is to say, for example, a surface of at least one side wall of the cleaning chamber and/or a surface of at least one rear wall of the cleaning chamber. As an alternative to this or in addition to it, however, cooling surfaces are also possible, for example, in a front wall of the cleaning chamber and/or in a ceiling and/or in a floor of the cleaning chamber.

The term “thermally coupled”, as used here, is a further term to which its usual and common meaning is to be attributed, as understood by the expert. The term is not limited to a special or adapted meaning. The term can, without limitation, refer, in particular, to a connection between at least two elements which makes a heat exchange between the two elements possible. In particular, the thermal coupling can be effected by means of a thermally conductive connection which, for example, can be promoted or generated, for example by metal elements and/or heat-conducting pastes. In particular, the cooling surface can be an inner surface of a side wall of the cleaning chamber, which is produced in full or in part from a metal material and which produces a thermal connection between an interior of the cleaning chamber and consequently the cooling surface, on one hand, and the cooling container on the other hand.

The term “cooling container”, as used here, is a further term to which its usual and common meaning is to be attributed, as understood by the expert. The term is not limited to a special or adapted meaning. The term can, without limitation, refer, in particular, to a container which is set up in order to receive, permanently or temporarily, at least one cooling medium, in particular at least one liquid, and which preferably enables a heat exchange between the cooling medium, on the one hand, and at least one further element, for example the cooling surface. For possible examples of the design of the cooling container, reference can be made as an example to DE 10 2008 040 745 A1 or DE 10 2013 014 553 A1. Further possible and advantageous designs of the cooling container are described in more detail below. The at least one cooling container can include, for example, at least one inlet, for example at least one inlet support, and/or at least one outlet, for example at least one outlet support. In addition, the cooling container can be connected, for example, to at least one inlet valve and/or to at least one outlet valve, which can control, for example, an inlet and/or an outlet of cooling liquid.

The term “cooling liquid”, as used here, is a further term to which its usual and common meaning is to be attributed, as understood by the expert. The term is not limited to a special or adapted meaning. The term can, without limitation, refer, in particular, to a liquid which can be utilized as a heat exchanger. In particular, the liquid can be an aqueous liquid and in a particularly preferred manner, water, for example fresh water.

The term “regeneration step”, as used here, is a further term to which its usual and common meaning is to be attributed, as understood by the expert. The term is not limited to a special or adapted meaning. The term can, without limitation, refer, in particular, to a program, a method step or a sequence of operations which exert an action on the cleaning device in such a manner that reverses entirely or in part a gradual change in the cleaning device brought about by the operation. In particular, the regeneration step can include a step or a program which cleans, regenerates or returns at least one element of the cleaning device in another manner to the original state or at least brings said original state closer again. In the present case, the regeneration step can bring about, in particular, a decrease in deposits, in particular of biofilms, in the cooling container which can form over time in the cooling container during the operation of the cleaning device. In particular, an at least partially germicidal action on organisms can be achieved in the cooling container during the regeneration step so that the number of microorganisms in the cooling container overall is reduced in the regeneration step.

The term “control system”, as used here, is a further term to which its usual and common meaning is to be attributed, as understood by the expert. The term is not limited to a special or adapted meaning. The term can, without limitation, refer, in particular, to a one-part or multi-part device of the cleaning device which is set up in order to control and/or to regulate in full or in part an operation of the cleaning device. In particular, the control system can be set up in order to modify, in particular to control and/or to regulate, one or multiple operating parameters of the cleaning device, for example at least one temperature, at least one pressure, at least one valve position, at least one pump activity or also a combination of the named and/or other operating parameters. The control system can include, in particular, at least one data processing device, for example at least one processor. The control system can be set up, in particular, from a program technology point of view, for example, in order to control at least one cleaning program of the cleaning device and in order to control or carry out a method according to the invention. In addition, the control system can include at least one volatile and/or non-volatile data memory. In addition, the control system can include at least one interface, for example a man-machine interface for inputting commands and/or for outputting data, and/or a wireless or wired interface for unidirectional or bidirectional exchange of data and/or commands between the cleaning device and at least one further device. The control system can include at least one computer and/or at least one processor. The control system can be, in particular a central or decentral machine controller of the cleaning device.

The control system can be set up in particular as regards program technology for carrying out the method steps. For example, the control system can be set up, in particular as regards program technology, in order to actuate at least one inflow valve of the cooling container, for example a fresh water valve, for carrying out the method step a). For carrying out method step b), the control system can be set up, in particular as regards program technology, in order to fill a tank, in particular a cleaning tank or wash tank, of the cleaning device via, for example, at least one valve, in order to heat the cleaning fluid in the wash tank, for example by actuating at least one heater in the wash tank, and then, for example by actuating at least one circulation pump, to circulate the cleaning fluid in the cleaning chamber via, for example, the nozzle system, in such a manner that the cooling surface is moistened with heated cleaning fluid so that the cooling container and/or the cooling liquid in the cooling container is heated via the cooling surface. As an alternative to this or in addition to it, the cooling container can also be heated in another manner, for example by the cooling container comprising at least one heating device or being coupled with such a heating device which can be actuated once again, for example, by the control system. For carrying out method step c), the control system can be set up, in particular as regards program technology, in order to actuate at least one valve, for example at least one outflow valve, so that the cooling liquid is able to drain out of the cooling container. As an alternative to this or in addition to it, it can also be pumped out for example

The above-described cleaning device and the described method comprise numerous advantages compared to known devices and methods of the named type. In particular, the formation of a coating in the cooling container can be avoided or at least reduced as a result of carrying out the at least one regeneration step in a regular or even irregular manner by microorganisms in the cooling container being killed, for example, in a regular or even irregular manner. As a result, an effect of the cooling container during the drying of the articles to be cleaned which reduces over time can be at least largely avoided, or the reduction in the effect can be at least slowed down by the formation of coatings in the cooling container being able to be reduced or slowed down. Thermal germicide in the cooling container can consequently be achieved overall in the regeneration step.

The cleaning device and the method can be further designed and improved in various ways as an option. Said options can be realized individually or also in arbitrary combination as the expert will know.

The cleaning device can thus comprise, in particular, at least one temperature sensor for detecting at least one temperature of the cooling liquid in the cooling container. The temperature sensor can be arranged, for example, inside the cooling container or also, for example, on an outside surface of the cooling container, thermally coupled with an interior of the cooling container. When the temperature of the cooling liquid in the cooling container is detected, the control system is able to utilize said temperature data in various ways. For example, heating of the cooling container and/or of the cooling liquid in the cooling container can be detected so that, for example, as is described in more detail below, the number of heat equivalents transmitted to the cooling liquid and or to the cooling container can be detected. It is possible to ensure in this manner that a minimum number of heat equivalents is transmitted to the cooling container, for example a minimum number of heat equivalents necessary for killing microorganisms efficiently. The temperature sensor can be, for example, a conventional temperature sensor, for example at least one temperature-dependent resistor. Other designs are also possible.

The control system and the method can be set up, in particular, in order to detect and/or establish a current temperature in the cooling container. In this case, multiple temperatures can also be detected and/or established, for example at various points inside the cooling container, for example to establish an average value. The control system can be set up, in particular, in order to establish a current temperature in the cooling container by means of at least one method selected from: an estimation; an empirical value; an analytical model; a calibration curve; a calibration table. Estimates, empirical values, analytical models, calibration curves or also corresponding tables can be generated, for example, by corresponding calibration experiments, as known in principle to the expert. In this way, for example with known heating under known conditions, it is possible to predict a rise in temperature over time or also, when heating is switched off under predetermined conditions, it is possible to predict cooling.

As stated above, the control system and the method can be set up, in particular, in order to control the regeneration step in such a manner that the cooling container is acted upon with at least a predetermined minimum number of heat equivalents.

The term “heat equivalent”, as used here, is a further term to which its usual and common meaning is to be attributed, as understood by the expert. The term is not limited to a special or adapted meaning. The term can, without limitation, refer, in particular, to a variable which quantifies thermal hygienization or thermal germicide. In particular, the term heat equivalent can refer, in particular, to a variable which includes a temperature and a duration of the impact of the temperature. For example, the term heat equivalent can include at least one value, selected from an A0 value or an H.U.E value. As an alternative to this or in addition to it, for example, a different unit of measurement can be specified for a reduction in a population of at least one target germ. A0 values and H.U.E. values are a measurement for the reduction, or mortality rate, of a target germ as a result of a thermal effect. The higher the acting temperature, the greater the germ-reducing effect per unit time. For example, more A0 values and H.U.E. values can be achieved per second at a higher temperature. A0 values are defined, for example, in DIN EN ISO 15883, whereas H.U.E. units are defined, for example, in U.S. Standard NSF3.

For determining heat equivalents, the control system and the method can be set up, for example, in order to establish at least one temperature of the cooling container as a function of time and from this to determine the accumulated heat equivalents which act upon the cooling container. Such methods are known in principle to the expert. For example, weighted integration of the temperature can be effected over time or also the formation of a weighted sum can be effected over units of time, the weighting reflecting the germicidal effect at various temperatures.

As an alternative to or in addition to determining heat equivalents, the control system and the method, however, can also be set up simply in order to keep the temperature in the cooling container at a minimum temperature for at least a predetermined time. In this case, the duration predetermined as the minimum time can vary with the minimum temperature. For example, at low minimum temperatures, for example temperatures of 60-65° C., holding times of 1 minute are predetermined, whereas at a minimum temperature of 65-70° C., holding times of 50 seconds can be provided, and at temperatures above 70° C., holding times of 40 seconds. The control system and the method can be set up, for example, in order to monitor said holding times. In particular, the control system can be set up, for example, in order to hold the cooling container at a temperature of at least 60° C. for at least 1 minute, in particular at a temperature of at least 65° C. and in a particularly preferred manner at a temperature of at least 70° C. or at least 74° C. The control system and the method can be set up, in particular, in order to monitor reaching a predetermined required temperature or minimum temperature in the cooling container, the control system and the method being able to be set up additionally in order to wait for a predetermined interval after reaching the required temperature before step c) is carried out.

As stated above, the cleaning device can comprise at least one temperature sensor in the cooling container. Said temperature sensor can either be arranged in the cooling container itself or can be coupled in such a manner with the cooling container that a temperature of the cooling liquid in the cooling container can be determined. The control system and the method can be set up, in particular, in order to detect via the temperature sensor a temperature reached in step b). The control system and the method can additionally be set up in order to generate data via the temperature reached regarding heat equivalents transmitted to the cooling container.

The control system and the method can be set up, in particular, in order to fill the cooling container with fresh water in step a). The control system can open, for example, at least one fresh water valve for this purpose.

The control system and the method can additionally be set up in order to heat the cooling liquid in the cooling container in method step b) as a result of heated cleaning fluid in the cleaning chamber. For this purpose, for example in method step b), a cleaning tank of the cleaning device, for example a wash tank in the floor of the cleaning chamber, can be filled with cleaning fluid, the cleaning fluid heated and the heated cleaning fluid circulated in the cleaning chamber in circulation mode by means of the application device so that the heated cleaning fluid heats the cooling container and the cooling liquid located therein via the cooling surface. As an alternative to this or in addition to it, heating can also be effected, however, by means of at least one heating element which heats the cooling container and/or the cooling liquid directly or indirectly and which can be actuated by the control system.

The control system can be, as stated above, a machine controller of the automatic program machine which, along with the at least one regeneration step, can additionally control one or multiple further programs and/or steps. Said further programs and/or steps can be, for example, regular cleaning programs. In particular, the control system can be set up, for example, in order to control at least one cleaning step in the cleaning device, the articles to be cleaned being acted upon with the cleaning fluid in the cleaning step. The regeneration step and the cleaning step can be, in particular, separate steps so that, for example, no articles to be cleaned are situated in the cleaning chamber during the regeneration step. As an alternative to this or in addition to it or also with the at least one cleaning step, the control system can additionally be set up in order to control at least one drying step in the cleaning device, the articles to be cleaned being dried in the drying step. The regeneration step and the drying step can be, in particular, separate steps. The drying step can also be part of a cleaning program which includes at least one cleaning step and at least one drying step. For the drying step, cooling liquid can be received, for example, in the at least one cooling container or else can flow through the at least one cooling container. As a result of said cooling, for example, condensation of moisture, which vaporizes from the articles to be cleaned, is effected on the cooling surface in the interior of the cleaning chamber.

The control system can additionally be set up in order to carry out at least one self-cleaning step of the cleaning device, the cleaning device being filled with fresh cleaning fluid in the self-cleaning step and the fresh cleaning fluid being circulated in the cleaning device by means of the application device. The regeneration step can be, in particular, a component part of the self-cleaning step. Such self-cleaning steps are already known today in numerous cleaning devices, in particular in industrial dishwashing machines. For example, the control system can be set up in order to request a user of the cleaning device to carry out the self-cleaning step at the end of an operation of the cleaning device, for example after an operating phase and in particular in the evening. Said request can be effected, for example, by means of a display, an illuminated key, acoustically or in another manner

The reduction of microorganisms in the cooling container can be supported in another manner in addition to thermal reduction. For example, the control system and the method can be set up in order to actuate at least one wash step in which the cooling container is washed through, for example by an inlet valve and an outlet valve being opened at the same time. As an alternative to this or in addition to it, the control system and the method can also be set up in order to actuate or to implement at least one blow-out step in which the cooling container is blown out with pressurized gas, for example in order to bring about drying of the cooling container. The formation of biofilms is typically reduced in dry atmosphere compared to in moist atmosphere. Thus, the cleaning device can additionally comprise, for example, at least one pressurized gas source and/or at least one pressurized gas connection. The control system and the method can be set up, in particular, in order to blow out the cooling container with pressurized gas, for example, pressurized air, after step c).

Further possible designs relate to the design of the cooling container. The cooling container can thus comprise, for example, a shell which is fitted to a wall of the cleaning chamber. For example, the at least one shell can be fitted directly or via at least one seal to a wall of the cleaning chamber, for example at least one side wall. The shell can be screw-connected, for example, to the wall or else, for example, welded or bonded. The shell can, in this case, cover the entire wall or else just a part. The intermediate space between the shell and the side wall can be kept small, for example, so that, for example, the shell is at a maximum distance of 50 mm, in particular a maximum distance of 40 mm, for example between 3 mm and 20 mm, from the side wall. An interior of the cooling container can be realized between the shell and the wall of the cleaning chamber, cooling liquid in the cooling container being in contact with the wall of the cleaning chamber. The shell can be produced, in particular, fully or in part from a material, selected from the group consisting of: a metal, in particular a metal sheet; a plastics material. The shell can be produced, for example, by means of a deep-drawing process and/or by means of an injection molding process and/or by means of another forming process, for example an embossing process and/or a stamping process.

Further measures can be taken for supporting the germicide and/or for further prevention of biofilms. For example, the cooling container can comprise at least one germicidal coating on at least one inner wall, in particular a coating with silver ions. As an alternative to this or in addition to it, the cooling container can comprise at least one water-repellent micro-structuring on at least one inner wall, in particular a micro-structuring with a lotus effect.

The drying of the articles to be cleaned, for example in the drying step, can be supported in various ways. For example, the cleaning device can be set up in order to generate an air flow in the cleaning chamber during drying, by means of which air flow, air enrichened with moisture, which is created by the vaporizing of moisture from the hot articles to be cleaned, is moved into contact with the cooling surface, where the moisture is able to condense and can drain away, for example, into the cleaning tank of the cleaning device. For the purpose of generating the air flow, the cleaning device can comprise, for example, at least one conveying device in the cleaning chamber. Said conveying device can comprise, in particular, at least one device, selected from the group consisting of: a blower, in particular a radial fan; a blade arm, in particular a nozzle arm with at least one blade.

As stated above, the cleaning device can be, in particular, but not compulsorily, an industrially utilizable cleaning device, in particular an industrially utilizable dishwashing machine. Correspondingly, the cleaning device can additionally comprise, in particular, at least one rinse tank. Said rinse tank can be realized, in particular, separately from the cleaning tank of the cleaning device, which is usually arranged on the floor of the cleaning chamber. The rinse tank can comprise, in particular, at least one boiler and/or at least one flow heater in order to heat rinse liquid in the rinse tank, in particular independently of the operations in the cleaning chamber, so that a rinse can be effected directly after a main washing step without a time-consuming water change or change of liquid in the cleaning chamber, combined with renewed heating there, being necessary. The cleaning device can be set up, in particular, in order to transfer the cooling liquid out of the cooling container into the rinse tank in method step c). In this way, the heat of the cooling liquid, which can be, in particular, fresh water, can be utilized for the rinse step, for example in a connecting cycle. In addition, the cleaning device can comprise at least one temperature sensor in the rinse tank, and the method and the control system can be set up in order to detect a temperature reached in step b) in the cooling container by means of the temperature sensor. In this way, a temperature sensor present in any case, as a rule, in the rinse tank can also be utilized for carrying out the regeneration step and for controlling said regeneration step. Correspondingly, the control system and the method can also be set up in order to generate data on heat equivalents transmitted to the cooling container via the achieved temperature.

As stated above, a cleaning device according to one or multiple of the above-described designs and/or according to one or multiple of the embodiments described in more detail below can be used, in particular, with the proposed method.

The proposed method can be carried out, in particular, implemented by computer in full or in part. In a further aspect, a computer program with program code means is correspondingly proposed, which computer program is set up in order, once loaded in a control system of a cleaning device, to cause the control system to carry out the method steps II. a.-c.

The cleaning device and the proposed method can be realized simply and efficiently in practice. The method and the proposed cleaning device take into account, in particular, the fact that the coatings, recognized as a disadvantage within the framework of the present invention, are created in the cooling container as a rule from biofilms, that is to say as a result of settlement of the inner surfaces of the cooling container with germs which are introduced in regular operation with the fresh water. In order to suppress growth of the coating, a special program can be carried out to avoid the biofilm within the framework of the present invention. In said special program the cooling containers, which as a rule abut against the outside of the cleaning chamber and/or the tank, can be filled, for example, entirely with water. The wash water located in the tank is then circulated. The wash water can then be heated, for example, via a tank heating body. The required temperature can lie, in this connection, for example, above the wash temperature used typically for a wash step, for example within the framework of the above-described cleaning step, for example above the wash temperature of a normal wash program of, for example, 60° C. The required temperature in the regeneration step can be, for example, 74° C.

As the container abuts, as a rule, against the outside of a tank wall of the cleaning chamber, heat can be exchanged from the wash water through the tank wall into the cooling container that is filled with water. As the container is filled with water and the thermal conductivity of water is significantly higher than that of air, the entire cooling container, as a rule, is heated through in a short time. Germ reduction can take place in said cooling container as a result of the increased temperature.

In order to obtain a defined reduction in germs, the program sequence can be carried out according to a certain, validated method, for example corresponding to the A0 value method. The temperature and the time can be determined to this end. This can be realized and in particular monitored using various methods. The following procedures, for example, can be used:
i. Once the required temperature of the wash water has been reached, a defined time can be waited, during which, for example on account of tests, it is to be assumed that the cooling container is heated through completely up to, for example, a predetermined temperature. The time taken until a defined A0 value is reached can then be measured.
ii. Said procedure can be carried out analogously to method i., it being possible, however, then to drain the water in the container into a rinse tank connected down-stream, in particular a boiler, in order to measure the temperature of the heated water there, as a result of which a successful heat-through can be confirmed.
iii. In said third possible variant at least one temperature sensor can be situated on the cooling container, for example on the outside. Said temperature sensor can be situated, for example, at a point at which the heat-through is reached last when the wash water is heated to a required temperature, for example at the bottom of the cooling container. When the temperature, which can be relevant, for example, to the A0 value method, is reached, a successful heat-through can then be assumed and a hold time, which is necessary as a rule, can expire.

The cooling liquid, for example the water, can then be drained out of the cooling container into the rinse tank or else into a drain.

The regeneration step, for example the special regeneration program, can be, for example, part of a program for producing the operational readiness of the cleaning device once the cleaning device has been switched on or part of the self-cleaning process when the cleaning device has been switched off. An independent special program to avoid a biofilm which can be selected and started manually, for example, between individual wash cycles or else can be started automatically, is equally conceivable. For example, the control system of the cleaning device can request the user to start said program after evaluation of a usage profile.

In order to implement the described method in a particularly effective manner, the cooling container is preferably realized in a shell-like manner so that, for example, a wall of the cleaning chamber, for example a tank wall, forms a wall of the cooling container at the same time. As a result, the stored cooling liquid, for example the stored water, comes into contact preferably directly with the wall of the cleaning chamber, for example the tank wall, so that the heat transfer can be effected in the best possible manner both in regular operation and in the case of the proposed program.

The at least one cooling container, cooling containers being able to be situated on multiple sides of the cleaning chamber, can preferably be realized in full or in part as a sheet metal shell. The sheet metal shell can be fastened, for example by means of screw bolts and a seal on the wall of the cleaning chamber, for example the tank wall. The connections for the supply and removal of the cooling water are preferably introduced, for example welded, into the shell, in particular the upper shell. If necessary, guide elements can be used to influence the through-flow in the interior. It is also conceivable for the upper shell to be welded directly on the tank wall. Instead of an upper shell of sheet metal, a realization in plastics material would also be conceivable. In principle, one or also multiple cooling containers can be fitted to the tank wall. In order to achieve maximum functioning during cooling of the hot moist air in the wash chamber at the end of the wash program, multiple cooling containers preferably cover a large part of the surface of the tank wall.

To sum up, without limitation to further possible designs, the following embodiments are proposed:

Embodiment 1: Cleaning device for cleaning articles to be cleaned, including at least one cleaning chamber for receiving the articles to be cleaned, in addition including at least one application device for acting upon the articles to be cleaned with at least one cleaning fluid, wherein the cleaning device additionally comprises at least one cooling surface which points to the cleaning chamber and at least one cooling container which is thermally coupled to the cooling surface for receiving a cooling liquid, wherein the cleaning device comprises at least one control system, wherein the control system is additionally set up to control at least one regeneration step in the cleaning device, wherein the regeneration step includes the following substeps:
a) fill the cooling container with cooling liquid;
b) heat the cooling liquid in the cooling container; and
c) remove the cooling liquid from the cooling container.

Embodiment 2: Cleaning device according to the preceding embodiment, wherein the cleaning device comprises at least one temperature sensor for detecting at least one temperature of the cooling liquid in the cooling container.

Embodiment 3: Cleaning device according to any one of the preceding embodiments, wherein the control system is set up in order to establish a current temperature in the cooling container by means of at least one method selected from: an estimation; an empirical value; an analytical model; a calibration curve; a calibration table.

Embodiment 4: Cleaning device according to any one of the preceding embodiments, wherein the control system is set up in order to control the regeneration step in such a manner that the cooling container is acted upon with at least one predetermined minimum number of heat equivalents.

Embodiment 5: Cleaning device according to the preceding embodiment, wherein the control system is set up in order to determine at least one temperature of the cooling container as a function of time and from this to determine the cumulated heat equivalents which act upon the cooling container.

Embodiment 6: Cleaning device according to any one of the preceding embodiments, wherein the control system is set up in order to hold the cooling container for at least 1 minute at a temperature of at least 60° C., in particular at a temperature of at least 65° C. and in a particularly preferred manner at a temperature of at least 70° C. or at least 74° C.

Embodiment 7: Cleaning device according to any one of the preceding embodiments, wherein the control system is set up in order to monitor reaching a predetermined required temperature in the cooling chamber, wherein the control system is additionally set up in order to wait for a predetermined time interval after reaching the required temperature before step c) is carried out.

Embodiment 8: Cleaning device according to any one of the preceding embodiments, wherein the cleaning device comprises at least one temperature sensor in the cooling container, wherein the control system is set up in order to detect a temperature reached in step b) in the cooling container by means of the temperature sensor.

Embodiment 9: Cleaning device according to the preceding embodiment, wherein the control system is additionally set up in order to generate data via the temperature reached regarding heat equivalents transmitted to the cooling container.

Embodiment 10: Cleaning device according to any one of the preceding embodiments, wherein the control system is set up in order to fill the cooling container with fresh water in step a).

Embodiment 11: Cleaning device according to any one of the preceding embodiments, wherein the control system is set up in order to heat the cooling liquid in the cooling container as a result of heated cleaning fluid in the cleaning chamber in method step b).

Embodiment 12: Cleaning device according to the preceding embodiment, wherein in method step b), a cleaning tank of the cleaning device is filled with cleaning fluid, the cleaning fluid is heated and the heated cleaning fluid is circulated in the cleaning chamber in circulation mode by means of the application device so that the heated cleaning fluid heats the cooling container and the cooling liquid located therein via the cooling surface.

Embodiment 13: Cleaning device according to any one of the preceding embodiments, wherein the control system is additionally set up in order to control at least one cleaning step in the cleaning device, wherein the articles to be cleaned are acted upon with the cleaning fluid in the cleaning step, wherein the regeneration step and the cleaning step are separate steps.

Embodiment 14: Cleaning device according to any one of the preceding embodiments, wherein the control system is additionally set up in order to control at least one drying step in the cleaning device, wherein the articles to be cleaned are dried in the cleaning chamber in the drying step, wherein the regeneration step and the drying step are separate steps.

Embodiment 15: Cleaning device according to any one of the preceding embodiments, wherein the control system is additionally set up in order to carry out at least one self-cleaning step of the cleaning device, wherein the cleaning device is filled with fresh cleaning fluid in the self-cleaning step and wherein the fresh cleaning fluid is circulated in the cleaning device by means of the application device, wherein the regeneration step is a component part of the self-cleaning step.

Embodiment 16: Cleaning device according to the preceding embodiment, wherein the control system is set up in order to request a user of the cleaning device to carry out the self-cleaning step at the end of an operation of the cleaning device.

Embodiment 17: Cleaning device according to any one of the preceding embodiments, wherein the cleaning device additionally comprises at least one pressurized gas source and/or at least one pressurized gas connection, wherein the control system is set up in order to blow out the cooling container with pressurized gas after step c).

Embodiment 18: Cleaning device according to any one of the preceding embodiments, wherein the cooling container comprises a shell, wherein the shell is fitted onto a wall of the cleaning chamber directly or by means of at least one seal, wherein an interior space of the cooling container is realized between the shell and the wall of the cleaning chamber, wherein cooling liquid is in contact with the wall of the cleaning chamber in the cooling container.

Embodiment 19: Cleaning device according to the preceding embodiment, wherein the shell is produced fully or in part from a material, selected from the group consisting of: a metal, in particular a metal sheet; a plastics material.

Embodiment 20: Cleaning device according to any one of the preceding embodiments, wherein the cooling container comprises at least one germicidal coating, in particular a coating with silver ions, on at least one inner wall.

Embodiment 21: Cleaning device according to any one of the preceding embodiments, wherein the cooling container comprises at least one water-repellent micro-structuring, in particular a micro-structuring with lotus effect, on at least one inner wall.

Embodiment 22: Cleaning device according to any one of the preceding embodiments, wherein the cleaning device additionally comprises at least one conveying device in the cleaning chamber for generating an air flow in the cleaning chamber past the cooling surface.

Embodiment 23: Cleaning device according to the preceding embodiment, wherein the conveying device comprises at least one device, selected from the group consisting of: a blower, in particular a radial fan; a blade arm, in particular a nozzle arm with at least one blade.

Embodiment 24: Cleaning device according to any one of the preceding embodiments, wherein the cleaning device additionally comprises at least one rinse tank, wherein the cleaning device is set up in order to transfer the cooling liquid out of the cooling container into the rinse tank in method step c).

Embodiment 25: Cleaning device according to the preceding embodiment, wherein the cleaning device comprises at least one temperature sensor in the rinse tank, wherein the control system is set up in order to detect a temperature reached in step b) in the cooling container by means of the temperature sensor.

Embodiment 26: Cleaning device according to the preceding embodiment, wherein the control system is additionally set up in order to generate data via the temperature reached regarding heat equivalents transmitted to the cooling container.

Embodiment 27: Method for cleaning articles to be cleaned, including the following steps:
I. provide at least one cleaning device, including at least one cleaning chamber for receiving the articles to be cleaned, additionally including at least one application device for acting upon the articles to be cleaned with at least one cleaning fluid, wherein the cleaning device additionally comprises at least one cooling surface which points to the cleaning chamber and at least one cooling container which is thermally coupled with the cooling surface for receiving a cooling liquid;
II. carry out at least one regeneration step in the cleaning device, including the following substeps:
   a. fill the cooling container with cooling liquid;
   b. heat the cooling liquid in the cooling container; and
   c. remove the cooling liquid from the cooling container.

Embodiment 28: Method according to the preceding embodiment, wherein a cleaning device according to one of the preceding claims relevant to a cleaning device is used in the method.

Embodiment 29: Computer program having program code, wherein the computer program is set up in order, once loaded in a control system of a cleaning device, to cause the control system to carry out the method steps II. a.-c. of the method according to one of the two preceding embodiments.

### BRIEF DESCRIPTION OF THE FIGURES

Further details and features are produced from the following description of exemplary embodiments, in particular in connection with the subclaims. In this connection, the respective features can be realized on their own or in multiples in combination with one another. The invention is not restricted to the exemplary embodiments. The exemplary embodiments are shown schematically in the figures. Identical reference numbers in the individual figures designate, in this case, identical elements or elements with the same functions or elements which correspond to one another as regards their functions.

The figures in detail are as follows:

FIG. 1 shows an embodiment of a cleaning device; and

FIG. 2 shows a sequence plan of a possible embodiment of a method for cleaning articles to be cleaned.

### DESCRIPTION OF THE EXEMPLARY EMBODIMENTS

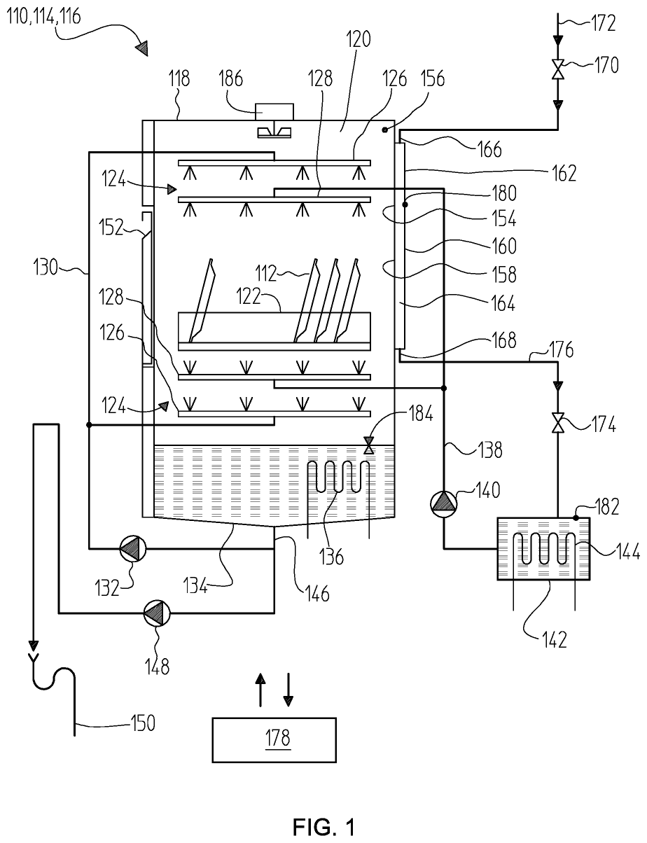

FIG. 1 shows a possible exemplary embodiment of a cleaning device 110 according to the invention for cleaning articles 112 to be cleaned. The cleaning device 110, in the exemplary embodiment shown, is designed as an example as a chamber dishwashing machine 114, in particular for industrial use, and is designed in a particularly preferred manner as an automatic program machine 116.

The cleaning device 110 includes a cleaning chamber 118, in the interior 120 of which the articles 112 to be cleaned can be received, for example by means of one or multiple baskets 122. The articles 112 to be cleaned can be acted upon with cleaning fluid in the cleaning chamber 118 via at least one application device 124, for example via a wash nozzle system 126 and/or via a rinse nozzle system 128. The wash nozzle system 126 can be supplied in circulation mode, for example via a wash line 130 and a circulating pump 132, from a cleaning tank or wash tank 134, which can be heatable via a heating body 136 or another type of heating. The rinse nozzle system 128 can be supplied with rinse fluid, for example fresh water, from a rinse tank 142 via at least one rinse line 138 and one rinse pump 140. A further heating device 144 can be provided, for example, in the rinse tank 142 so that the rinse tank 142 can be designed, for example, as a boiler and/or a flow heater.

An outlet 146, via which cleaning fluid can be conveyed into a drain 150 by means of a drain pump 148, is additionally provided in the floor of the wash tank 134. The cleaning chamber 118 can comprise at least one door 152 and/or at least one other device for opening the cleaning chamber 118. For example, said door 152 can be arranged in a front wall of the cleaning chamber 118 pointing to the user.

In addition, at least one rear wall 154 and/or at least one side wall 156 of the cleaning chamber 118 can provide at least one cooling surface 158 which points to the cleaning chamber 118. As an example, the cooling surface 158 is arranged on the rear wall 154 in FIG. 1. A cooling container 160 is thermally coupled with the cooling surface 158, in this case, for example, via the metal rear wall 154 and/or in another manner Said cooling container 160 is mounted on an outside of the rear wall 154 and/or on at least one outside of at least one side wall 156, for example said cooling container 160 can comprise at least one shell 162 which is preferably fitted directly to the rear wall 154 and is connected thereto, for example, via a seal. The shell 162 can be screw-connected and/or welded and/or bonded, for example, to the rear wall 154. As a result, an interior 164, into which cooling liquid, for example fresh water, can be introduced via an inflow 166, is formed between the shell 162 and the rear wall 154. The cooling liquid can be removed from the interior 164 again via an outflow 168. The inflow 166 can be connected to a fresh water line 172, for example, via at least one inflow valve 170, and cooling liquid can be drained from the cooling container 160 via an outflow valve 174 and a outflow line 176, for example into the rinse tank 142, into the wash tank 134 or also into the drain 150.

The cleaning device 110 additionally includes a control system 178, by means of which a program sequence in the cleaning device 110 can be controlled. The control system 178 can include, for example, at least one computer and/or at least one processor as well as at least one user interface. The control system 178 can actuate, for example, the pumps 132, 140, 148 and/or the valves 170, 174 as well as further components of a cleaning device 110. In addition, the control system 178 can refer to sensor data, for example data of at least one optional temperature sensor 180 on the cooling container 160, data of at least one optional temperature sensor 182 on the rinse tank 142 and/or data of at least one level sensor 184 in the wash tank 134.

The cleaning device 110, in particular the control system 178, can be set up in order to allow at least one wash program or cleaning program in the cleaning device 110 to drain away, which wash program or cleaning program, as explained in more detail below, can include at least one cleaning step and at least one drying step. Whilst the at least one cleaning step can include, for example in a sequential manner, being acted upon with wash liquid via the wash nozzle system 126 and then being acted upon with rinse liquid via the rinse nozzle system 128, the drying step includes drying of the articles to be cleaned 112. For drying, the cooling container 160 can be filled with cooling liquid, for example cold fresh water, so that the cooling surface 158 is cooled as a result. Moisture which vaporizes from the articles 112 to be cleaned can condense on said cooling surface 158 and drain off into the wash tank 134. Said drying process can be promoted by at least one conveying device 186, for example a radial fan, by means of which air circulation in the cleaning chamber 118 is promoted so that air saturated regularly with moisture passes to the cooling surface 158.

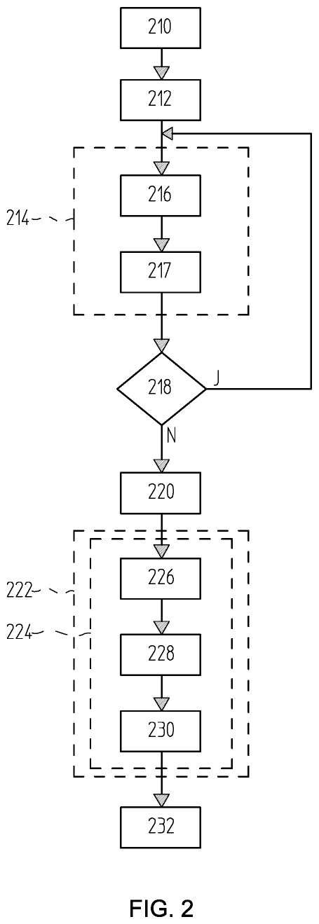

FIG. 2 describes an exemplary embodiment of a possible method for cleaning articles to be cleaned. Said method initially includes a start 210 of the operation of the cleaning device 110, for example according to the exemplary embodiment in FIG. 1. Said start can be initiated, for example, by activating a main switch. The control system 178 can then be set up, for example as a result of a corresponding selection via a user interface, in order to carry out a start of a cleaning program (step 212 in FIG. 2). Said cleaning program, designated by way of reference number 214 in FIG. 2, includes, for example, one or multiple cleaning steps 216, for example the above-described at least one wash step and the above-described at least one rinse step. In addition, the cleaning program 214 can include, for example, at least one drying step 217 where the above-described drying is carried out.

Once the cleaning program 214 has finished, interrogation is possible, for example, (interrogation 218) as to whether the cleaning program 214 is to be carried out once again, for example once the cleaned articles 112 to be cleaned have been unloaded and the cleaning chamber 118 has been loaded with new, dirty articles 112 to be cleaned. If this is the case, (branch designated by way of “J” in FIG. 2), the cleaning program 214 is carried out once again. If this is not the case (branch “N” in FIG. 2), the operation, for example, can thus be terminated. This can be connected as an option to the start of a self-cleaning program (step 220 in FIG. 2). In the case of said self-cleaning program, designated by way of the reference number 222 in FIG. 2, first of all, for example, the contaminated cleaning fluid can be pumped off via the outlet 146 and the drain pump 148 into the drain 150, and the wash tank 134 can be filled with fresh cleaning fluid, for example fresh water, and heated, for example via the heating body 136. The fresh cleaning fluid can then be circulated in the self-cleaning program 222 via the circulation pump 134 and the wash nozzle system 126 so that parts of the cleaning device 110 lying on the inside are cleaned in circulation mode. In this case, sieves, for example, can also be removed or other parts washed.

A regeneration step 224 is preferably part of the self-cleaning program 222. In the case of said regeneration step 224, the cooling container 160 is thermally treated to reduce microorganisms in the cooling container 160 and consequently to avoid biofilms in said cooling container 160. In said regeneration step 224, the cooling container 160 is first of all filled with cooling liquid, for example fresh water, for example as a result of opening the inflow valve 170 (step 226). In this case, the outflow valve 174 is preferably closed. The cooling liquid is then heated 228. This is preferably effected as a result of the above-described circulation mode in the cleaning chamber 118. The cooling liquid can thus be heated, for example, as a result of the cleaning fluid in the cleaning chamber 118 contacting the cooling surface 158, as the cleaning fluid, as described above, is preferably heated by means of the heating body 136. Said heating is preferably effected to a temperature which is above the temperatures usually occurring in the cleaning program 214, for example to temperatures above 60° C., for example temperatures of at least 65° C., at least 70° C. or at least 74° C. The temperature in the cooling container 160 can be detected, for example, via the temperature sensor 180. The control system 178 can establish the heat equivalents transmitted to the cooling container 160 from this. As an alternative to this or in addition to it, the control system 178, however, can also be set up in order to keep the cooling container 160 at a described minimum temperature for at least a predetermined period of time so that a predetermined thermal effect can be ensured. The cooling liquid can then be removed, for example emptied, from the cooling container 160 in step 230, in particular into the rinse container 142. The control system 178 can open the outflow valve 174, for example, for this purpose. As an alternative to or in addition to monitoring the temperature by means of the temperature sensor 180, it is also possible to use the temperature sensor 182, for example, by way of which, for example, it is ensured that the cooling liquid transferred into the rinse container 142 comprises a predetermined minimum temperature so that, in this way too, it is possible to ensure being acted upon with a minimum number of heat equivalents and/or a minimum hygienization of the cooling container 160. Once again as an alternative to this or in addition to it, for example, it is also possible to use other methods in order to detect, for example, a temperature in the cooling container 160 during a heating process 228, for example estimated values, empirical values or similar methods.

Once the self-cleaning program 222, also designated as the self-cleaning step, has been carried out, the operation of the cleaning device 110 can then be terminated (step 232).

### LIST OF REFERENCES

110 Cleaning device
112 Articles to be cleaned
114 Single chamber dishwashing machine
116 Automatic program machine
118 Cleaning chamber
120 Interior
122 Basket
124 Application device
126 Wash nozzle system
128 Rinse nozzle system
130 Wash line
132 Circulation pump
134 Wash tank
136 Heating body
138 Rinse line
140 Rinse pump
142 Rinse tank
144 Heating device
146 Outlet
148 Drain pump
150 Drain
152 Door
154 Rear wall
156 Side wall
158 Cooling surface
160 Cooling container
162 Shell
164 Interior
166 Inflow
168 Outflow
170 Inflow valve
172 Fresh water line
174 Outflow valve
176 Outflow line
178 Control system
180 Temperature sensor
182 Temperature sensor
184 Level sensor
186 Conveying device
210 Start
212 Start cleaning program
214 Cleaning program
216 Cleaning step
217 Drying step
218 Interrogation
220 Start self-cleaning program
222 Self-cleaning program
224 Regeneration step
226 Fill with cooling liquid
228 Heat the cooling liquid
230 Remove the cooling liquid
232 End of the operation

1. A cleaning device for cleaning articles to be cleaned, including at least one cleaning chamber for receiving the articles to be cleaned, in addition including at least one application device for acting on the articles to be cleaned with at least one cleaning fluid, wherein the cleaning device additionally comprises at least one cooling surface which points to the cleaning chamber and at least one cooling container which is thermally coupled with the cooling surface for receiving a cooling liquid, wherein the cooling surface includes an inner wall of the cleaning chamber which points to the cleaning chamber, wherein the inner wall is coolable by the cooling liquid on an outside which is arranged outside the cleaning chamber, wherein the cleaning device comprises at least one control system, wherein the control system is additionally set up to control at least one regeneration step in the cleaning device device, wherein the regeneration step includes the following substeps:
a) fill the cooling container with cooling liquid;
b) heat the cooling liquid in the cooling container; and
c) remove the cooling liquid from the cooling container.

2. The cleaning device as claimed in claim 1, wherein the control system is set up in order to control the regeneration step in such a manner that the cooling container is acted upon with at least a predetermined minimum number of heat equivalents, wherein the heat equivalents are a variable which quantifies thermal hygienization or thermal germicide and which includes a temperature and a period of time of an effect of the temperature.

3. The cleaning device as claimed in claim 2, wherein the control system is set up in order to establish at least one temperature of the cooling container as a function of time and to establish from this the accumulated heat equivalents, with which the cooling container is acted upon.

4. The cleaning device as claimed in claim 1, wherein the control system is set up in order to keep the cooling container at a temperature of at least 60° C. for at least 1 minute.

5. The cleaning device as claimed in claim 1, wherein the control system is set up in order to monitor reaching a predetermined required temperature in the cooling container, wherein the control system is additionally set up in order to wait for a predetermined time interval after reaching the required temperature before step c) is carried out.

6. The cleaning device as claimed in claim 1, wherein the control system is set up in order to heat the cooling liquid in the cooling container in method step b) as a result of heated cleaning fluid in the cleaning chamber.

7. The cleaning device as claimed in claim 6, wherein in method step b), a cleaning tank of the cleaning device is filled with cleaning fluid, the cleaning fluid is heated and the heated cleaning fluid is circulated in the cleaning chamber in circulation mode by means of the application device so that the heated cleaning fluid heats the cooling container and the cooling liquid located therein via the cooling surface.

8. The cleaning device as claimed in claim 1, wherein the control device is additionally set up in order to control at least one cleaning step in the cleaning device, wherein the articles to be cleaned are acted upon with the cleaning fluid in the cleaning step, wherein the regeneration step and the cleaning step are separate steps.

9. The cleaning device as claimed in claim 1, wherein the control system is additionally set up in order to control at least one drying step in the cleaning device, wherein the articles (112) to be cleaned are dried in the cleaning chamber in the drying step, wherein the regeneration step and the drying step are separate steps.

10. The cleaning device as claimed in claim 1, wherein the cleaning device additionally comprises at least one pressurized gas source and/or at least one pressurized gas connection, wherein the control system is set up in order to blow out the cooling container with pressurized gas after step c).

11. The cleaning device as claimed in claim 1, wherein the cooling container comprises a shell, wherein the shell is fitted onto a wall of the cleaning chamber directly or by means of at least one seal, wherein an interior space of the cooling container is realized between the shell and the wall of the cleaning chamber, wherein cooling liquid is in contact with the wall of the cleaning chamber in the cooling container.

12. The cleaning device as claimed in claim 1, wherein the cooling container comprises at least one germicidal coating on at least one inner wall.

13. The cleaning device as claimed in claim 1, wherein the cooling container comprises at least one water-repellent micro-structuring on at least one inner wall.

14. A method for cleaning articles to be cleaned including the following steps:
I. provide at least one cleaning device, including at least one cleaning chamber for receiving the articles to be cleaned, additionally including at least one application device for acting upon the articles to be cleaned with at least one cleaning fluid, wherein the cleaning device additionally comprises at least one cooling surface which points to the cleaning chamber and at least one cooling container which is thermally coupled with the cooling surface for receiving a cooling liquid, wherein the cooling surface includes an inner wall of the cleaning chamber which points to the cleaning chamber, wherein the inner wall is coolable by the cooling liquid on an outside which is arranged outside the cleaning chamber;
II. carry out at least one regeneration step in the cleaning device, including the following substeps:
a. fill the cooling container with cooling liquid;
b. heat the cooling liquid in the cooling container; and
c. remove the cooling liquid from the cooling container.

15. A computer program having program code, wherein the computer program is set up in order, once loaded in a control system of a cleaning device, to cause the control system to carry out the method steps II. a.-c. of the method as claimed in the preceding claim 14.

16. The cleaning device as claimed in claim 12, wherein the germicidal coating comprises a coating with silver ions.

17. The cleaning device as claimed in claim 13, wherein the water-repellent micro-structuring comprises a micro-structuring with lotus effect.
